(19) United States
(12) Patent Application Publication
(10) Pub. No.: US 2019/0220902 A1
(43) Pub. Date: Jul. 18, 2019

(54) INFORMATION ANALYSIS APPARATUS, INFORMATION ANALYSIS METHOD, AND INFORMATION ANALYSIS PROGRAM

(71) Applicant: So-net Media Networks Corp., Tokyo (JP)

(72) Inventors: Hayato SAKATA, Tokyo (JP); Kei TATENO, Tokyo (JP); Noriyuki YAMAMOTO, Tokyo (JP); Kentaro UEDA, Tokyo (JP)

(21) Appl. No.: 16/179,092

(22) Filed: Nov. 2, 2018

(30) Foreign Application Priority Data
Jan. 12, 2018 (JP) 2018-003289

(51) Int. Cl. G06Q 30/02

(52) U.S. Cl. CPC G06Q 30/0271; G06Q 30/0277; G06Q 30/0255

(57) ABSTRACT

A target user specification unit that specifies a specific action user indicated by action history information included in user data to have reached a specific state as an analysis target user and specifies a user different from the analysis target user as a comparison target user, a comparison analysis unit that analyzes feature information of the analysis target user having peculiarity with respect to the feature information of the comparison target user, and an analysis result output unit that outputs an analysis result thereof are provided, and by comparing the feature information on the action history between the user (analysis target user) who has reached the specific state and the other users (comparison target users) and by analyzing and outputting feature information peculiar to the analysis target user, it is possible to grasp the feature information on the peculiar action history when the user has reached the specific state.

### TECHNICAL FIELD

The present invention relates to an information analysis apparatus, an information analysis method, and an information analysis program, and more particularly, is suitable for use in an apparatus that analyzes action history information of a user and provides information useful for marketing.

### BACKGROUND ART

In the related art, it has been generally practiced to find some characteristic trends by analyzing action histories of many users and to use the found trends or features for marketing. For example, in advertisement distribution or the like, there is known a system which can provide information useful for targeting of the advertisement distribution by analyzing users having features similar to that of a user (for example, a consumer who purchased a product) taking a certain action (refer to, for example, PTL 1, PTL 2, and PTL 3).

In an information processing system disclosed in PTL 1, on the basis of a database illustrating features relating to consumption actions of each consumer belonging to a first consumer group (a consumer group of which consumer data is registered in a first purchase database) and a database illustrating features relating to consumer actions of each consumer belonging to a second consumer group (a group of consumers who agree to collection of various kinds of data such as data on purchasing actions, data on on-line actions, and data on attitude survey), a consumer group in the second consumer group that has features similar to those of a consumer group (a consumer group that exhibits consumer actions meeting conditions specified by a user) represented in a consumer list partially selected as an advertisement distribution from the first consumer group is determined as a target group.

In addition, in an extraction apparatus disclosed in PTL 2, an action history of a user that is a content distribution candidate is acquired, and on the basis of an action history specified by a content provider from the acquired action history, target users that are expected to take a specific action are extracted. More specifically, on the basis of an action history of a first user which is a content delivery candidate and an action history of a second user which includes a specific action in the action history, by generating a model of determining similarity between the first user and the second user and inputting the action history of the first user to the model, the first user who has been determined to have a similarity to the second user equal to or larger than a predetermined threshold value is extracted as a target user who is expected to take the specific action.

In addition, PTL 3 discloses a technique where, on the basis of the fact that there is an advertisement that increases a possibility of conversion (for example, purchasing of a product or service) and there is an advertisement that reduces the possibility of the conversion, in order to discriminate effective advertisements from adversely affecting advertisements (for example, advertisements that keep the users from the conversion) or avoidable advertisements (for example, advertisements that do not influence decision of conversion of frequently appearing users in a conversion route), distribution of advertisement impression in the conversion route together with overall distributions and the distribution in a non-conversion route is analyzed.

For example, in a case where an advertisement appears frequently on the conversion route but also appears similarly frequently as a whole, since the appearance of the advertisement in the conversion route does not increase the possibility of the conversion, it is analyzed that the performance of the advertisement is not good. In addition, in a case where the overall appearance frequency is higher than the appearance frequency of a certain advertisement in the conversion route, it is analyzed that the advertisement suppresses the conversion.

According to the techniques disclosed PTL 1 and PTL 2 described above, for example, it is possible to extract another user having an action history with a high similarity to an action history of a user who has reached the conversion as the user who is an advertisement distribution target. However, this is not because all the action histories of the users who have reached the conversion are not necessarily information useful for marketing (for example, information useful for guiding other users to the conversions). Therefore, there is a problem that it is not always possible to provide useful information for consumer targeting merely by extracting other users having action histories with a high similarity to action histories of users who have reached the conversions.

According to the technique disclosed in PTL 3, by analyzing the distribution of the advertisement impression in the conversion route together with the overall distributions or distribution in the non-conversion route, it is possible to distinguish the distributed advertisements into the advertisements that are effective for guiding the users to the conversion and the advertisements that are ineffective for guiding the users to the conversion. However, in the technique disclosed in PTL 3, the advertisements that are not effective for the conversion can be determined, but what kind of actions and features of the user are effective for the conversion cannot be analyzed.

In addition, PTL 1 discloses a technique of outputting a history of accesses of the target group determined as described above by referring to the history data representing the history of access to the information medium for each consumer belonging to the second consumer group. For example, there is disclosed a technique of comparing the access amount of the access target (web page) by the consumer group with access amount of the access target by the consumer group other than the whole of the second consumer group or a target group included in the second consumer group and ranking the access amounts by the target groups in a descending order.

According to the technique disclosed in PTL 1, by analyzing the web page that a consumer group having features similar to those of the consumer groups exhibiting a predetermined consumption action (for example, a consumer group having a purchase history of a certain product) accesses more than the other groups, it is possible to distribute the advertisement to the advertisement area of the web page. In PTL 1, the advertisement distribution setting can be performed by targeting a consumer group which is likely to purchase a certain product and a web page which the consumer group frequently accesses. However, it cannot be analyzed which actions and features of the users are effective to encourage a predetermined consumer action. The analysis of the actions and features that encourage the consumers to take consumption actions is important not only for targeting of advertisement distribution but also for producing advertisements and setting strategies to product design. However, in the related art, there is a problem in that the analysis is not sufficient.

### PRIOR ART DOCUMENT

### Patent Literature

[PTL 1] JP-A-2017-97717

[PTL 2] JP-A-2016-38822

[PTL 3] JP-A-2014-532238

### SUMMARY OF THE INVENTION

The invention has been made to solve such a problem and an object of the invention is to grasp what kind of actions or features of a user is effective in order for the user to reach a specific state.

### Solution to Problem

In order to solve the above problem, according to the invention, on the basis of a plurality of pieces of user data having at least action history information, at least a portion of specific action users indicated by the action history information to have reached a specific state is specified as an analysis target user, a comparison target user different from the analysis target user is specified, feature information of the analysis target user having peculiarity with respect to the feature information of the comparison target user is analyzed, and an analysis result thereof is output.

### Effect of the Invention

According to the invention configured as described above, by comparison of the feature information on the action history between at least a portion of the users (analysis target users) who have reached the specific state and the other users (comparison target users), the feature information peculiar to the analysis target user is analyzed and output. Therefore, it is possible to grasp the feature information on the peculiar action history in order for the user to reach the specific state, and it is possible to grasp what kind of actions or features of the user is effective for reaching the specific state.

### BRIEF DESCRIPTION OF THE DRAWINGS

FIG. 1 is a block diagram illustrating a functional configuration example of an information analysis apparatus according to a first embodiment;

FIG. 2 is a diagram illustrating an example of a graphic display output by an analysis result output unit;

FIG. 3 is a diagram illustrating an example of a graphic display output by the analysis result output unit;

FIG. 4 is a diagram illustrating an example of a graphic display output by the analysis result output unit;

FIG. 5 is a flowchart illustrating an operation example of the information analysis apparatus according to the first embodiment;

FIG. 6 is a block diagram illustrating a functional configuration example of an information analysis apparatus according to a second embodiment;

FIG. 7 is a diagram illustrating an example of a graphic display output by an analysis result output unit;

FIG. 8 is a block diagram illustrating a functional configuration example of an information analysis apparatus according to a third embodiment;

FIG. 9 is a diagram illustrating an operation example of a target user specification unit according to the third embodiment;

FIG. 10 is a diagram illustrating an example of a graphic display output by an analysis result output unit;

FIG. 11 is a flowchart illustrating an operation example of an information analysis apparatus according to an application example and an advertisement distribution system used in combination with the information analysis apparatus; and

FIG. 12 is a block diagram illustrating a functional configuration example of an information analysis apparatus according to a fourth embodiment.

### DESCRIPTION OF THE INVENTION

### First Embodiment

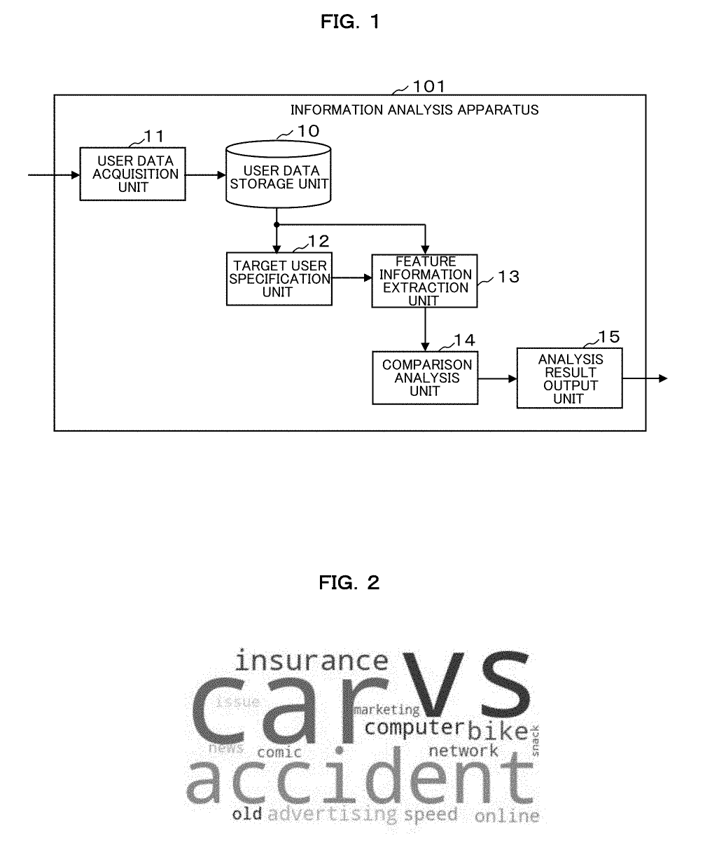

Hereinafter, a first embodiment of the invention will be described with reference to the drawings. FIG. 1 is a block diagram illustrating a functional configuration example of an information analysis apparatus 101 according to the first embodiment. As illustrated in FIG. 1, the information analysis apparatus 101 according to the first embodiment includes, as a functional configuration, a user data acquisition unit 11, a target user specification unit 12, a feature information extraction unit 13, a comparison analysis unit 14, and an analysis result output unit 15. In addition, the information analysis apparatus 101 according to the first embodiment includes a user data storage unit 10 as a storage medium.

Each of the functional blocks 11 to 15 can be configured by hardware, a digital signal processor (DSP), or software. For example, in a case where the functional blocks are configured by software, each of the functional blocks 11 to 15 is actually configured with a CPU, a RAM, a ROM, and the like of a computer and is realized by allowing a program stored in a recording medium such as a RAM, a ROM, a hard disk or a semiconductor memory to be operated.

The user data acquisition unit 11 acquires a plurality of pieces of user data having at least action history information. Herein, the action history information is history information in which, for example, various actions performed by a user as a consumer of a product or service (hereinafter, simply referred to as a product) are recorded together with the date and time when the action was taken.

For example, in a case of the action history information on purchase of products sold on the Internet, information in which various actions such as browsing of web pages, browsing of advertisements arranged in web pages, manipulation of various buttons arranged in web pages, registration of favorite product information, registration of products in a shopping cart, purchasing of products, and distribution of the information on purchased products to other users are recorded together with execution dates and times of the actions is the action history information acquired by the user data acquisition unit 11. In addition, words used as keywords in searching web pages, words uttered to AI speakers, or the like may be included as a portion of the action history information.

A series of the action histories relating to one user is recorded in association with identification information which can uniquely identify individual users, for example. As the identification information of the user, cookies stored in a web browser of a terminal (personal computer, smart phone, tablet, or the like) used by a user, an IP address of the terminal used by the user, a user ID individually issued to each user, or the like can be used.

Analysis tags based on JavaScript (registered trademark) are embedded beforehand in the web page from which the action history information as described above is to be acquired. This analysis tag is a well-known simple program that is capable of collecting access logs to web pages. When the web page in which the analysis tag is embedded is accessed, the program is executed, the access log information on the various action histories described above is acquired and transmitted to a predetermined log collection server.

The access log information accumulated in the log collection server is acquired by the analysis tag in the web page when a plurality of users access various web pages. The individual access log information accumulated in the log collection server is managed so as to be able to identify to which user the access log information is associated by the identification information of the user.

The user data acquisition unit 11 of the information analysis apparatus 101 acquires the access log information accumulated in the log collection server in this manner as a plurality of pieces of user data including the action history information. Herein, the user data acquisition unit 11 can acquire user data from the log collection server via the communication network. Alternatively, the user data acquisition unit 11 may acquire the user data transmitted from the log collection server to the removable storage medium and stored therein from the removable storage medium.

The method of acquiring the user data by the user data acquisition unit 11 is not limited to the example described above. For example, the user data acquisition unit 11 itself may be configured as a log collection server. In addition, when a web page is accessed, the access log information is recorded in a web server managing the web page. The user data acquisition unit 11 may transmit a data acquisition request to each of a plurality of web servers managing a plurality of web pages to be acquired for the action history information and may be allowed to acquire user data from each of the plurality of web servers.

The acquisition of the user data from the log collection server can be performed at an arbitrary timing. For example, each time the access log information (action history information) is added to the log collection server, the user data acquisition unit 11 can acquire the access log information as the user data. In addition, the user data acquisition unit 11 may acquire the user data as a response by transmitting a data acquisition request to the log collection server periodically or in response to an explicit user manipulation by an analyst. In this case, all the access log information accumulated in the log collection server at the time of transmitting the data acquisition request may be acquired, or only the access log information corresponding to the difference from the access log information at the last time of transmitting the request may be acquired. Alternatively, only the access log information in the target period designated by the analyst may be acquired.

In addition, recently, users who check contents of products on web pages and, after that, go to offline shops to purchase the products are increasing. In the case of such a user, visiting to an offline shop and purchasing of a product at an offline shop can also be included as the action history information. Whether or not the user has visited an offline shop can be detected, for example, by matching the current position information detected by the position detection device such as a GPS or the like mounted on a portable terminal used by the user and map data where the position of the offline shop is recorded. That is, when the user carrying the terminal equipped with the position detection device visits the offline shop, a POS (Point of Sale System) server of the offline shop or the like acquires the current position information from the terminal of the user through a wireless communication tag. Then, the visiting to the offline shop is detected by matching the current position information with the map data, and the visiting action is recorded in the POS server or the like of the offline shop in association with the identification information of the user.

In addition, whether or not the user has purchased a product in the offline shop can be detected, for example, by determining whether or not the user has used an electronic coupon that can be used when purchasing the product. That is, when a certain product is purchased at the offline shop, if the electronic coupon downloaded from the web page relating to the product to the portable terminal of the user is recognized, for example, by reading the electronic coupon by a reader of the offline shop, the using action of the electronic coupon (that is, purchasing action of the product) is recorded in the POS server or the like of the offline shop in association with the identification information of the user.

The user data acquisition unit 11 of the information analysis apparatus 101 acquires the action history information accumulated in the POS server in this manner as a plurality of pieces of user data including the action history information. Herein, the user data acquisition unit 11 can acquire the user data from the POS server via the communication network. Alternatively, the user data acquisition unit 11 may acquire the user data, which is transmitted from the POS server to a removable storage medium and stored therein, from the removable storage medium.

The user data acquired by the user data acquisition unit 11 is stored in the user data storage unit 10.

On the basis of the plurality of pieces of user data (that is, the user data stored in the user data storage unit 10) acquired by the user data acquisition unit 11, the target user specification unit 12 specifies at least a portion of the users (hereinafter, referred to as “specific action users”) indicated by the action history information to have reached the specific state as analysis target users and specifies users different from the analysis target users as the comparison target users.

First, an analysis target user will be described. The “specific state” in the definition of the analysis target user includes, for example, a state where the user has browsed the advertisement of the product, a state where the user has browsed the product detail page, a state where the user has visited an offline shop, a state where the user has purchased the product, a state where the user has shared information of the purchased product with other users, and arbitrary states. That is, the specific state can be arbitrarily designated by an analyst manipulating a manipulation unit (keyboard, mouse, touch panel, or the like) (not shown) of the information analysis apparatus 101.

In a case where analysis based on a purchasing action model such as AIDMA, AIDA, AISAS, AIDCA, or SIPS that is well-known in marketing is intended to be performed, actions corresponding to stages of the model are defined in advance, any one of the defined actions may be designated as the “specific state”.

For example, in the case of designating the state where the user has browsed the advertisement of the product as the “specific state”, by designating the URL (Uniform Resource Locator) of the web page where the advertisement is posted, the user of which access log to the URL is recorded in the action history information is specified as the analysis target user. Alternatively, if a banner advertisement arranged in the web page is designated, the user of which click log of the banner advertisement is recorded in the action history information is specified as the analysis target user.

In the case of specifying the state where the user has browsed the product detail page as the “specific state”, by designating the URL of the product detail page, the user of which access log to the URL is recorded in the action history information is specified as the analysis target user. Alternatively, a link button to the product detail page displayed on the web page may be allowed to be designated. In this case, the user of which manipulation of the link button is recorded in the action history information is specified as the analysis target user.

In the case of designating the state where the user has visited an offline shop as the “specific state”, for example, by designating the position information of the offline shop, the user of which the visiting action to the shop indicated by the position information is recorded as the action history information is specified as the analysis target user. In addition, in the case of designating the state where the user has purchased a product as “specific state”, for example, by designating the identification information of the product, the user of which the purchasing action of the product indicated by the identification information is recorded as the action history information is specified as the analysis target user.

In addition, in the case of designating the state where the user has shared the information on the purchased products with other users as the “specific state”, for example, designating the identification information of the product and a share button displayed on the web page, the user of which the purchasing action of the product indicated by the identification information and the manipulation of the share button are recorded as the action history information is specified as the analysis target user.

Although details on the specific methods for designating the other “specific states” are omitted, as described above, by designating the information relating to the specific state, the user of which the designated information is recorded as the action history information can be specified as the analysis target user. In addition, a plurality of the specific states may be arbitrarily combined and designated by using AND conditions or OR conditions.

In this embodiment, all of the specific action users who have reached the specific state described above may be used as the analysis target user, or a portion thereof may be extracted to be used as the analysis target user. The condition for extracting a portion of the specific action users can be arbitrarily designated by the analyst manipulating the manipulation unit of the information analysis apparatus 101. For example, on the basis of the action history information included in the user data, a user who has reached the specific state within a period designated by the analyst or a user having the action history information within the period may be extracted and set as the analysis target user. The other conditions can be arbitrarily designated.

Next, the comparison target user will be described. The comparison target user can also be arbitrarily designated by the analyst manipulating the manipulation unit of the information analysis apparatus 101. For example, a complementary set of analysis target users or a subset thereof can be designated as comparison target users.

As an example, in the case of designating the state where the user has purchased a certain product as the “specific state” and specifying the analysis target user, a user who has not purchased the product is specified as a comparison target user. In this case, for example, by designating the identification information of the product, the user of which the purchasing action of the product indicated by the identification information is not recorded as the action history information is specified as the comparison target user. In addition, by designating further different information by an AND condition, the user who satisfies (or does not satisfy) the condition among the users who have not purchased the product can be specified as a subset.

In this manner, by specifying the user who is in a complementary set relationship to the analysis target user as the comparison target user, extraction of the feature information on a certain action which exists in the analysis target user but does not exist in the comparison target user can be performed. In this manner, by extracting the feature information on the action peculiar to the analysis target user, it is possible to estimate policies useful for transitioning the comparison target user (the user who did not purchase the product) to the analysis target user (the user who purchased the product). The detailed analysis content relating to the extraction of the feature information peculiar to the analysis target user will be described later.

Note that, the comparison target user is not limited to the users who are in a complementary set relationship to the analysis target user. The conditions to be satisfied by the comparison target user can be arbitrarily designated according to the contents to be clarified by comparison analysis between the analysis target user and the comparison target user. For example, a user who purchased a product A (for example, a product of a certain company) may be specified as the analysis target user, and a user who purchased a product B (for example, a product of a competitor) may be specified as the comparison target user. In this case, it is possible to estimate the superiority or inferiority of the product A to the product B on the basis of the comparison analysis result.

In addition, by targeting the same user and using the date and time indicated by the action history information when the advertisement was browsed as the boundary, the state after browsing may be specified as the analysis target user, and the state before browsing may be specified as the comparison target user. In this case, it is possible to estimate the presence or absence and a degree of attitude change of the user by the advertisement browsing on the basis of the comparison analysis result. Furthermore, the user who has browsed the banner advertisement may be specified as the analysis target user, and the user who has browsed the other advertisement (for example, mail advertisement) maybe specified as the comparison target user. In this case, it is possible to estimate the presence or absence and a degree of attitude change of the user by individual advertisement policies on the basis of the comparison analysis result.

Note that, the analysis target users and the comparison target users listed herein are examples, and thus, the analysis target users and the comparison target users are not limited thereto. By arbitrarily designating the analysis target user and the comparison target user, it is possible to analyze actions peculiar to the analysis target user and feature information specified from the actions from various points of view.

The feature information extraction unit 13 extracts the feature information of the analysis target user on the basis of the action history information of the analysis target user specified by the target user specification unit 12 and extracts the feature information of the comparison target user on the basis of the action history information of the comparison target user. For example, the feature information extraction unit 13 extracts the words included in the web page, the category information and the like set as the metadata in the web page as the feature information of the analysis target user from the web page indicated by the action history information of the analysis target user to have been accessed. In addition, in a case where the position information of the shop visited by the user is recorded as the action history information of the analysis target user, the feature information extraction unit 13 also extracts the position information as the feature information of the analysis target user. Furthermore, the word that the user has used for searching the web page and the word that has been uttered to the AI speaker are also extracted as the feature information of the analysis target user.

Similarly, the feature information extraction unit 13 extracts the words included in the web page, the category information and the like set as the metadata in the web page as the feature information of the comparison target user from the web page indicated by the action history information of the comparison target user to have been accessed. In addition, in a case where the position information of the shop visited by the user is recorded as the action history information of the comparison target user, the feature information extraction unit 13 also extracts the position information as the feature information of the comparison target user. Furthermore, the word that the user has used for searching the web page and the word that has been uttered to the AI speaker are also extracted as the feature information of the analysis target user.

Well-known techniques may be applied to the extraction of words from web pages. For example, morphological analysis is performed on a character string of text data included in a web page, and words relating to a specific part of speech (noun, verb, or the like) are extracted from the decomposed morphemes. In this case, all the words of specific part of speech appearing in the web page may be extracted as the feature information, or only those satisfying a predetermined condition may be extracted. For example, it is possible to set a condition of extracting only words appearing more than a predetermined number of times within one web page or a condition of extracting only words of which display size is set to be larger than other words or words for which a specific decoration mark is set.

Note that, the feature information extracted with respect to the analysis target user and the comparison target user is not limited to those exemplified herein. For example, the URL of the web page of the access destination recorded as the action history information may be extracted as the feature information. Alternatively, predetermined feature information may be set in advance as metadata in a web page in which an analysis tag is embedded, and in a case where the action history information indicates that the web page has been accessed, the feature information may be extracted from the metadata.

The comparison analysis unit 14 analyzes the feature information of the analysis target user having peculiarity with respect to the feature information of the comparison target user. That is, the comparison analysis unit 14 extracts the feature information that exists (or abundantly exists) in the analysis target user but does not exist (or scarcely exist) in the comparison target user. For example, the comparison analysis unit 14 extracts feature information and combination thereof that exist in the analysis target user but do not exists in the comparison target user, by performing comparison analysis by using a well-known semi-supervised topic model or the like. In this case, the comparison analysis unit 14 may calculate the degree of peculiarity of the feature information of the analysis target user with respect to the feature information of the comparison target user, and analyze the feature information of which the degree of peculiarity satisfies a predetermined condition as the feature information (hereinafter, referred to as peculiar information) having peculiarity.

The method of comparison analysis using a semi-supervised topic model will be described below. First, the number of analysis target users and the number of comparison target users are denoted by n1 and n2, respectively, and n=n1+n2 is defined. When the dimension number of the feature information (the number of pieces of feature information extracted by the feature information extraction unit 13) is m, the feature information X can be written as X ∈ R^{n×m}.

It is considered to decompose the feature information X in a space of latent dimension number k. The latent dimension number k corresponds to the number of groups, that is, the number of topics in a case where a plurality of pieces of feature information are grouped by predetermined common items (topics). For example, in the case of grouping a plurality of pieces of feature information (words in the following example) as follows (Table 1), the latent dimension number k (the number of topics) is “5”.

TABLE 1

| Topic | Feature Information |
|---|---|
| 1 | blog, Information, Attack, Summary, Recommendation |
| 2 | Small Car, Purchasing, New Car, Used Car, Comparison |
| 3 | Disease State, Cause, Health, Disease Symptom, Female |
| 4 | Car Insurance, Insurance, Life Insurance, Comparison, Ranking |
| 5 | Procedure, Transfer of Ownership, Car, Car Inspection, Change |

In addition, the grouping based on the topic of the feature information can be arbitrarily performed by the analyst manipulating the manipulation unit of the information analysis apparatus 101. In other words, topics that are desired to be clarified as types, attributes, categories, or the like of the feature information peculiar to the analysis target user may be defined in advance, and the words relating to the topic may be grouped.

Herein, as illustrated in the following Mathematical Formula 1, when two matrices W ∈ R^{n×k} and H ∈ R^{k×m} of which all elements are nonnegative are prepared, the feature information X can be expressed as Mathematical Formula 2.

$$\begin{matrix}W = ( \begin{matrix}{W}_{11} & … & {W}_{1 k} \\ ⋮ & ⋱ & ⋮ \\ {W}_{n 1} & … & {W}_{nk}\end{matrix} ) , \\ H = ( \begin{matrix}{H}_{11} & … & {H}_{1 m} \\ ⋮ & ⋱ & ⋮ \\ {H}_{k 1} & … & {H}_{k m}\end{matrix} ) & ( Mathimatical Formula 1 ) \\ X = W \cdot H & ( Mathimatical Formula 2 )\end{matrix}$$

The matrix W is a matrix indicating which topic each of n users including the analysis target users and the comparison target users belongs to. That is, a value of an element W_{i, j} (i=1 to n, j=1 to k) of the matrix W indicates a degree of affiliation for which the user i belongs to the j-th topic. The degree of affiliation is information indicating to what extent one or more pieces of the feature information extracted by the feature information extraction unit 13 with respect to the user matches the feature information included in each topic illustrated in Table 1. For example, in a case where one or more pieces of the feature information extracted for a certain user does not match any feature information included in a certain topic, the value of the degree of affiliation for the topic is “0”. On the other hand, as the number of matches between one or more pieces of the feature information extracted for a certain user and the feature information included in a topic is increased, the value of the degree of affiliation for the topic is increased.

The matrix H is a matrix indicating which of the plurality of pieces of the feature information included in each topic is the feature information representing the topic. That is, a value of an element H_{j, p} (j=1 to k, p=1 to m) of the matrix H indicates a degree of contribution of the p-th feature information to the j-th topic. The degree of contribution is information indicating the extent to which the feature information contributes to each topic, and similarly to the degree of affiliation of the matrix W, the degree of contribution has a value of 0 or more. This degree of contribution can be arbitrarily set in advance by an analyst.

In addition, a matrix F ∈ R^{n×1} including flags indicating whether each of n users is an analysis target user or a comparison target user is defined. In addition, a degree of peculiarity matrix C ∈ R^{k×1} indicating what extent to which each topic is peculiar to the analysis target user (that is, how much each topic contributes to the analysis target user or the comparison target user) is defined. Both of the matrices F and C are matrices including elements which are all nonnegative. In this case, the following mathematical formula can be expressed.

F=W·C (Mathematical Formula 3)

Herein, since it is preferable that two matrix decompositions expressed by Mathematical Formulas 2 and 3 are approximate to the original matrices X and F, an objective function to be minimized is expressed by the following Mathematical Formula 4.

μ·||X−W·H||₂+(1−μ)·||F−W·C||₂ (Mathematical Formula 4)

μ∈ [0, 1] is a hyper parameter (a parameter that is set in advance by an analyst) indicating a degree of emphasis on a structure of feature information.

The comparison analysis unit 14 determines the optimal matrices W, H, and C by minimizing the objective function illustrated in Mathematical Formula 4 by using a well-known KKT condition (Karush-Kuhn-Tucker condition) or the like. The following Table 2 adds numerical values of the degree of peculiarity indicated by the matrix C determined for each topic illustrated in the above Table 1.

TABLE 2

| Topic | Feature Information | degree of Peculiarity |
|---|---|---|
| 1 | blog, Information, Attack, Summary, | 0.341 |
| | Recommendation | |
| 2 | Small Car, Purchasing, New Car, | 0.351 |
| | Used Car, Comparison | |
| 3 | Disease State, Cause, Health, | 0.321 |
| | Disease Symptom, Female | |
| 4 | Car Insurance, Insurance, Life | 0.883 |
| | Insurance, Comparison, Ranking | |
| 5 | Procedure, Transfer of Ownership, | 0.462 |
| | Car, Car Inspection, Change | |

The comparison analysis unit 14 extracts the feature information of which the degree of peculiarity calculated as illustrated in Table 2 satisfies a predetermined condition as the feature information (peculiar information) where the analysis target user has peculiarity with respect to the comparison target user. For example, a topic having the highest degree of peculiarity or feature information included in the topic is extracted as the feature information peculiar to the analysis target user. In this case, all pieces of the feature information included in the topic having the highest degree of peculiarity may be extracted, or a predetermined number of pieces of the feature information may be extracted from the feature information with a greater degree of contribution as described above among the feature information included in the topic.

The analysis result output unit 15 outputs the result analyzed by the comparison analysis unit 14. Output of the analysis result may be performed by displaying on a display, by outputting to a printer, or by recording on a storage medium. The result analyzed by the comparison analysis unit 14 is the peculiar information analyzed as having peculiarity by the comparison analysis unit 14 as described above. This is the information indicating the topic extracted as peculiar to the analysis target user or the feature information included in the topic.

Note that, the analysis result output unit 15 may output only the peculiar information or may combine and output the peculiar information and other feature information (hereinafter, referred to as non-peculiar information) in such a manner that the peculiar information can be identified. For example, the peculiar information and other non-peculiar information are graphically output, and the peculiar information is output in a conspicuous manner as compared with the non-peculiar information. FIG. 2 is a diagram illustrating an example of a graphic display in this case. In the example of FIG. 2, the word relating to the peculiar information is displayed on the front side with a larger size as the degree of peculiarity becomes larger, and the word relating to the non-peculiar information is displayed on the back side with a smaller size as the degree of peculiarity becomes smaller. By performing such a display, the analyst can easily grasp the peculiar word relating to the analysis target user who has reached the specific state at a glance.

FIG. 2 illustrates an example of outputting the analysis result at a certain time point, but the analysis result may be output as time-series information. For example, the feature information extraction unit 13 delimits a plurality of target periods in units of a predetermined time period backward from the time point when the analysis target user has reached a specific state, and the feature information extraction unit 13 extracts the feature information of the analysis target user and the feature information of the comparison target user for each of the plurality of target periods. In addition, for each of the plurality of target periods, the comparison analysis unit 14 analyzes the feature information of the analysis target user having peculiarity with respect to the feature information of the comparison target user. Then, the analysis result output unit 15 outputs the result analyzed by the comparison analysis unit 14 for each of the plurality of target periods.

In the case of outputting the analysis result as the time-series information in this manner, the analysis result output unit 15 may output only the peculiar information, or may combine and output the peculiar information and other non-peculiar information in such a manner that the peculiar information can be identified. For example, the analysis result output unit 15 can graphically output the peculiar information and the non-peculiar information and output the peculiar information and the non-peculiar information in an identifiable manner for each of the plurality of target periods.

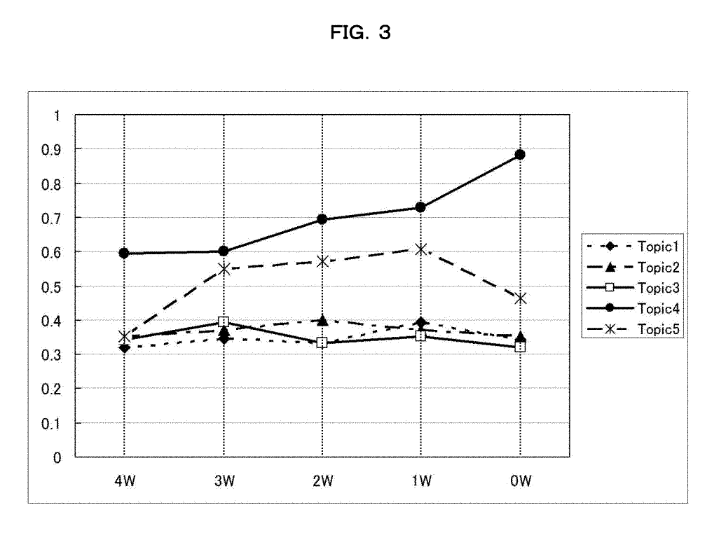

FIG. 3 is a diagram illustrating an example of graphically displaying the analysis results in time series. In the example of FIG. 3, in a two-dimensional coordinate system where the horizontal axis represents time and the vertical axis represents the degree of peculiarity of each topic, is illustrated a state where results analyzed after delimiting in units of one week backward from the time point when the analysis target user has reached a specific state (the right end point of the horizontal axis) are output as a polygonal line graph. The five polygonal lines are illustrated in FIG. 3, which illustrates the transition of the degree of peculiarity in units of one week with respect to the five topics illustrated in Table 2.

The graph of FIG. 3 illustrates that the peculiarity of Topic 4 of the analysis target user is rapidly increased in one week immediately before the analysis target user reached a specific state. From this, it can be predicted that it is effective to provide the information on Topic 4 to the user analyzed from the action history information that the user is in the stage just before reaching the specific state.

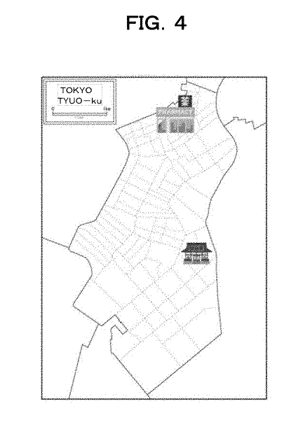

FIG. 4 is a diagram illustrating another example of a graphic display, illustrating a visualization mode specialized for the position information among the above-described peculiar information. In a case where the position information peculiar to the analysis target user (for example, a frequently visited shop) is analyzed by the comparison analysis unit 14, the analysis result output unit 15 visualizes the position information on the map. This allows the analyst to understand the geographic action pattern of the user.

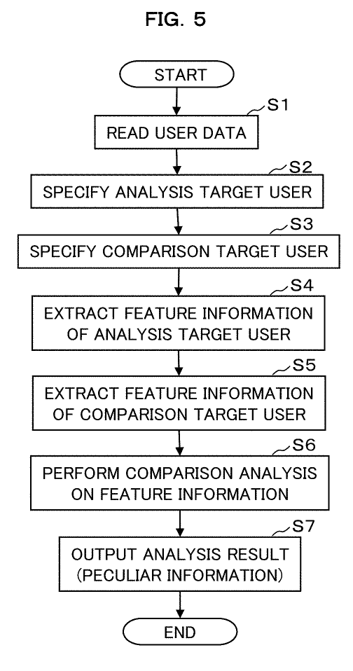

FIG. 5 is a flowchart illustrating an operation example of the information analysis apparatus 101 according to the first embodiment configured as described above. Herein, the acquisition of the user data by the user data acquisition unit 11 has already been performed, and an operation example of analyzing the user data stored in the user data storage unit 10 as a target is illustrated.

First, the target user specification unit 12 reads out a plurality of user data stored in the user data storage unit 10 (step S1). On the basis of the plurality of pieces of user data read out, the target user specification unit 12 specifies at least a portion of the specific action users indicated by the action history information included in the user data to have reached the specific state as the analysis target user (step S2). Herein, the “specific state” is arbitrarily designated by an analyst manipulating the manipulation unit of the information analysis apparatus 101. In addition, the condition for extracting at least a portion from the specific action users is also arbitrarily designated by the analyst.

In addition, the target user specification unit 12 specifies comparison target users different from the analysis target user among the plurality of pieces of user data read from the user data storage unit 10 (step S3). Herein, the condition to be satisfied by the comparison target user is arbitrarily designated by the analyst manipulating the manipulation unit of the information analysis apparatus 101 according to the content to be clarified by comparison analysis between the analysis target user and the comparison target user.

Next, the feature information extraction unit 13 extracts the feature information of the analysis target user on the basis of the action history information of the analysis target user specified by the target user specification unit 12 in step S2 (step S4). For example, the feature information extraction unit 13 extracts words included in a web page indicated by the action history information of the analysis target user to have been accessed, category information that is set as metadata for the web page, or the like as the feature information of the analysis target user.

In addition, the feature information extraction unit 13 extracts the feature information of the comparison target user on the basis of the action history information of the comparison target user specified by the target user specification unit 12 in step S3 (step S5). For example, the feature information extraction unit 13 extracts words included in a web page indicated by the action history information of the comparison target user to have been accessed, category information that is set as metadata for the web page, or the like as the feature information of the comparison target user.

Next, the comparison analysis unit 14 analyzes the feature information where the feature information of the analysis target user extracted by the feature information extraction unit 13 in step S4 has peculiarity in comparison with the feature information of the comparison target user extracted by the feature information extraction unit 13 in step S5. That is, the comparison analysis unit 14 extracts the feature information which does not exist in the comparison target user but exists in the analysis target user (step S6).

Finally, the analysis result output unit 15 outputs the result (feature information analyzed as having peculiarity) analyzed by the comparison analysis unit 14 to a display, a printer, a storage medium, or the like (step S7). For example, the analysis result output unit 15 may graphically output the peculiar information and other non-peculiar information in the same manner as illustrated in FIG. 2 or FIG. 3 so as to output the peculiar information in a conspicuous manner as compared with the non-peculiar information.

As described above in detail, in the first embodiment, on the basis of the plurality of pieces of user data having the action history information, at least a portion of the specific action users indicated by the action history information to have reached the specific state is specified as the analysis target users, users different from the analysis target user are specified as the comparison target users, the feature information where the feature information of the analysis target user having peculiarity with respect to the feature information of the comparison target user is analyzed, and the analysis result is output.

According to the first embodiment configured as described above, by comparing the feature information relating to the action history of at least a portion of users (analysis target users) among users who have reached a specific state and the feature information relating to the action history of other users (comparison target users), the feature information peculiar to the analysis target user is analyzed and output. Therefore, the analyst can grasp the feature information on the peculiar action history in order for the user to reach the specific state, and thus, it is possible to grasp what kind of actions or features of the user are effective for reaching the specific state.

As a result, it is possible to obtain information useful for reviewing marketing policies and strategies that are effective for allowing users (including comparison target users and other users) who have not yet reached the specific state to reach the specific state. Since the information obtained in this manner is information obtained from the analysis of the comparison results on the basis of the action history information of the specific action user and the action history information of the non-specific action user, it is possible to realize rational and effective marketing unlike inefficient marketing such as analyzer's arbitrariness and categorization by stereotype in the related art.

### Second Embodiment

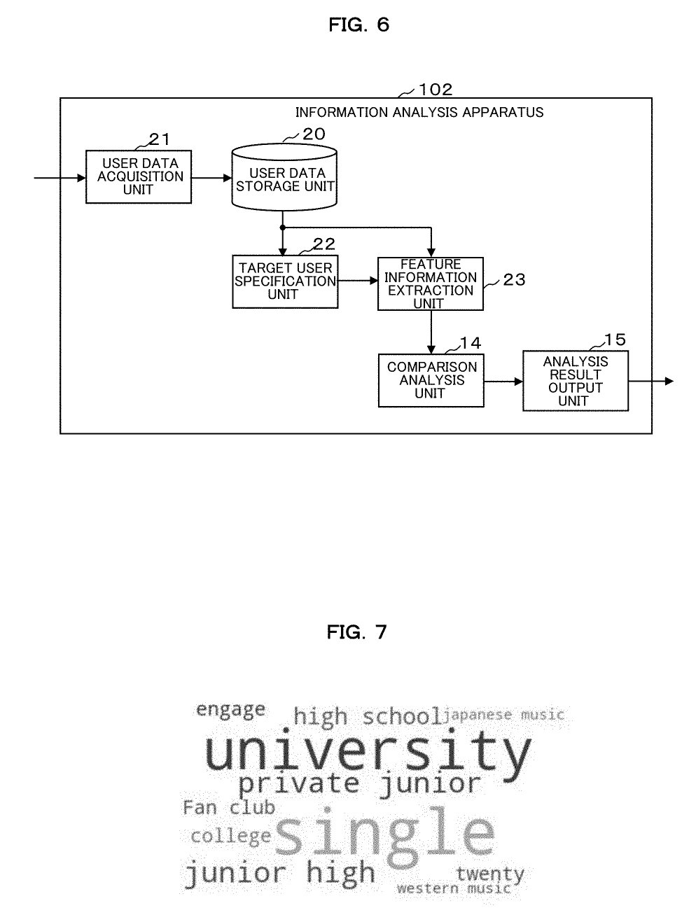

Hereinafter, a second embodiment of the invention will be described with reference to the drawings. FIG. 6 is a block diagram illustrating a functional configuration example of an information analysis apparatus 102 according to the second embodiment. In FIG. 6, the components denoted by the same reference numerals as those illustrated in FIG. 1 have the same functions, and thus, redundant descriptions are omitted herein.

As illustrated in FIG. 6, the information analysis apparatus 102 according to the second embodiment includes a user data acquisition unit 21, a target user specification unit 22, a feature information extraction unit 23, the comparison analysis unit 14, and the analysis result output unit 15. In addition, the information analysis apparatus 102 according to the second embodiment includes a user data storage unit 20 as a storage medium.

Each of the functional blocks 21 to 23 and 14 to 15 can be configured by any of hardware, DSP, and software. For example, in the case of being configured by software, each of the functional blocks 21 to 23 and 14 to 15 is actually configured with a CPU, a RAM, a ROM, and the like of a computer and is realized by operations of a program stored in a recording medium such as a RAM, a ROM, a hard disk, or a semiconductor memory.

In the second embodiment, the user data acquisition unit 21 acquires a plurality of pieces of user data having action history information and user attribute information. The contents of the action history information and the acquisition method thereof are the same as those described in the first embodiment. The user attribute information is information representing personal attributes such as gender, age, occupation, annual income, family composition, and residence. The user attribute information can be acquired, for example, through execution of a questionnaire. The user attribute information can also be acquired through estimation by machine learning with the questionnaire result as a positive example. In addition, the residence can be acquired through the current position information detected by the position detection device such as GPS mounted on the mobile terminal used by the user and estimation from the IP address.

The user attribute information is stored in the user data storage unit 20 in association with the action history information. This association can be performed by using the identification information (cookies accumulated in the web browser of the terminal used by the user, IP address of the terminal used by the user, User ID issued individually to individual users or the like) capable of uniquely identifying individual users. In the case of acquiring the user attribute information by the questionnaire to the user or the like as described above, if information is allowed to be acquired from the user data acquisition unit 21 through a predetermined answer input screen provided to the web browser of the terminal of the user, the user attribute information can be acquired in association with the cookies, the IP address, the user ID, or the like.

The user data acquired by the user data acquisition unit 21 is stored in the user data storage unit 20.

On the basis of the plurality of pieces of user data (that is, the user data stored in the user data storage unit 20) acquired by the user data acquisition unit 21, the target user specification unit 22 specifies the specific action user indicated by the user attribute information to have a specific user attribute and indicated by the action history information to have reached the specific state as the analysis target user and specifies users different from the analysis target user as the comparison target user. In the first embodiment described above, it is described that at least a portion of the specific action users indicated by the action history information to have reached the specific state is specified as the analysis target user, the second embodiment corresponds to the configuration where a condition of having specific user attribute is used as one of conditions of extracting a portion among the specific action users.

For example, among specific action users who have reached the specific state where a product has been purchased, males of twenties may be specified as the analysis target users, and among the specific action users who have reached the specific state where the same product has been purchased, females of twenties may be specified as the comparison target user. This is an example where the specific action user indicated by the action history information to have reached the specific state is specified as the analysis target user and users of which user attribute is different from that of the analysis target user is specified as the comparison target users.

On the contrary, among females of twenties, the specific action user who has reached the specific state where the product has been purchased may be specified as the analysis target user, and among the same females of twenties, non-specific action users who have not purchased the products may be specified as the comparison target user. This is an example where the specific action user indicated by the action history information to have reached the specific state is specified as the analysis target user and users of which user attribute is the same as that of the analysis target user but of which action history is different from that of the analysis target user are specified as the comparison target users.

The feature information extraction unit 23 extracts the feature information of the analysis target user on the basis of the action history information and the user attribute information of the analysis target user specified by the target user specification unit 22 and extracts the feature information of the comparison target user on the basis of the action history information and the user attribute information of the comparison target user. For example, the feature information extraction unit 23 extracts words included in a web page indicated by the action history information of the analysis target user to have been accessed, category information set as metadata for the web page, words that the user used for searching the web page, words that the user uttered to an AI speaker, and position information of the store visited by the user as the feature information of the analysis target user and extracts the user attribute information itself such as gender, age, occupation, annual income, family composition, residence, and birthplace as the feature information of the analysis target user.

Similarly, the feature information extraction unit 23 extracts words included in a web page indicated by the action history information of the comparison target user to have been accessed, category information set as metadata for the web page, words that the user used for searching the web page, words that the user uttered to an AI speaker, and position information of the store visited by the user as the feature information of the comparison target user and extracts the user attribute information itself such as gender, age, occupation, annual income, family composition, residence, and birthplace is extracted as the feature information of the comparison target user.

The comparison analysis unit 14 analyzes the feature information of the analysis target user having peculiarity with respect to the feature information of the comparison target user. That is, the comparison analysis unit 14 extracts the feature information which does not exist in the comparison target user but exists in the analysis target user as the peculiar information. The contents of the analysis performed by the comparison analysis unit 14 are the same as those described in the first embodiment. However, the second embodiment is different from the first embodiment in that the peculiar information extracted by the analysis includes the user attribute information such as gender, age, occupation, annual income, family composition, residence and birthplace in addition to the words, category information, and position information extracted from the action history information.

The analysis result output unit 15 outputs the analysis result by the comparison analysis unit 14 similarly to the first embodiment. Herein, by limiting the information source of the user data to be analyzed, it is possible to extract different features. For example, in the case of limiting the user data to be analyzed to a web page originating from SNS, if there is peculiarity in profile information such as occupation and a place of birth of the user and community information such as a friend relationship, the information is extracted as the feature information by the comparison analysis unit 14 and is displayed by the analysis result output unit 15 as illustrated in FIG. 7. The display of such analysis results is effective in situation where the place to utilize the peculiarity found is limited at such a site as advertisement distribution described later. This is because, for example, a user of a system having a platform capable of distributing advertisements only to the SNS does not have a method of using physical position information even though the physical position information is represented as peculiarity.

As described above in detail, in the second embodiment, on the basis of a plurality of pieces of user data having the action history information and the user attribute information, the specific action user which is indicated by the user attribute information to have a specific user attribute and indicated by the action history information to have reached the specific state is specified as the analysis target user, users different from the analysis target user are specified as the comparison target users, and the feature information of the analysis target user having peculiarity with respect to the feature information of the comparison target user is analyzed, an analysis result thereof is output.

According to the second embodiment configured as described above, the feature information peculiar to the analysis target user is analyzed and output by comparing the feature information on the action history and the user attribute between the analysis target user and the comparison target user. Therefore, the analyst can grasp the combination of the feature information on the peculiar action history and the peculiar user attribute in order for the user to reach the specific state, and it becomes possible to grasp what kind of actions or features of the user having what kind of attributes are effective for reaching the specific state. As a result, in considering the policies and strategies on the marketing, it is possible to obtain more useful information as compared with the first embodiment.

### Third Embodiment

Hereinafter, a third embodiment of the invention will be described with reference to the drawings. In the first and second embodiments described above, both the analysis target user and the comparison target user are specified on the basis of arbitrary conditions designated by the analyst manipulating the manipulation unit of the information analysis apparatus 101. On the other hand, in the third embodiment, at least one of the analysis target user and the comparison target user is automatically or semi-automatically specified. Three patterns will be described as a method for specifying the user.

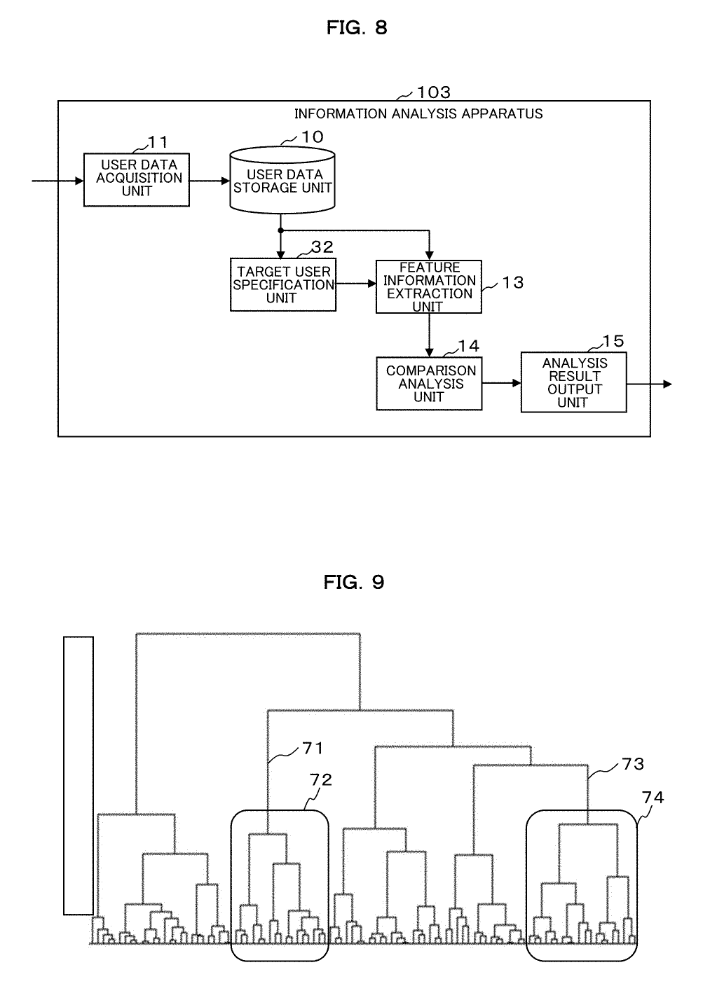

FIG. 8 is a block diagram illustrating a functional configuration example of an information analysis apparatus 103 according to the third embodiment. In FIG. 8, the components denoted by the same reference numerals as those illustrated in FIG. 1 have the same functions, and thus, redundant descriptions are omitted herein. Note that, herein, the third embodiment is illustrated as a modification to the first embodiment illustrated in FIG. 1, but the third embodiment may be applied as a modification to the second embodiment illustrated in FIG. 6.

As illustrated in FIG. 8, the information analysis apparatus 103 according to the third embodiment includes, as functional configurations, the user data acquisition unit 11, a target user specification unit 32, the feature information extraction unit 13, the comparison analysis unit 14, and the analysis result output unit 15. In addition, the information analysis apparatus 103 according to the third embodiment includes the user data storage unit 10 as a storage medium.

Each of the functional blocks 11, 32, and 13 to 15 can be configured by any of hardware, DSP, and software. For example, in the case of being configured by software, each of the functional blocks 11, 32, and 13 to 15 is actually configured with a CPU, a RAM, a ROM, and the like of a computer and is realized by operations of a program stored in a recording medium such as a RAM, a ROM, a hard disk, or a semiconductor memory.

<First Pattern>

The target user specification unit 32 extracts the feature information on the basis of the action history information by using the user data stored in the user data storage unit 10 with respect to each of the specific action users indicated by the action history information to have reached the specific state. Then, the specific action users are classified into a plurality of groups on the basis of the similarity of the extracted feature information, the specific action user belonging to one group is specified as the analysis target user, and the specific action user belonging to other groups is specified as the comparison target user.

Herein, the extraction of the feature information on the basis of the action history information may be the same as or different from the extraction of the feature information by the feature information extraction unit 13. In addition, various well-known techniques can be applied to a method of calculating the similarity of the extracted feature information and a method of classifying the users into a plurality of groups on the basis of the extracted similarity. For example, a hierarchical clustering such as the shortest distance method and a non-hierarchical method such as a k-means method can be performed on the feature information of the specific action user extracted by the target user specification unit 32.

As an example, in a case where a hierarchical clustering is applied, the target user specification unit 32 performs classification of the specific action users as follows. In this case, herein, it is assumed that n specific action users indicated by the action history information to have reached the specific state are extracted from the plurality of pieces of user data stored in the user data storage unit 10.

In this case, first, the target user specification unit 32 generates an initial state having n clusters including only one specific action user by using n pieces of the user data. In this state, n clusters exist in parallel in one hierarchy. Starting from this state, the target user specification unit 32 calculates the distance between the clusters from the distance representing the similarity or dissimilarity between the feature information of one specific action user and the feature information of other specific action users, combines two clusters with the closest distance consecutively, and constructs an upper hierarchy of the combined cluster. When constructing the upper hierarchy, the target user specification unit 32 calculates the distance between the clusters similarly for the upper hierarchies and combines the two clusters closest in distance to construct a higher hierarchy. Then, by repeating such combining until all the specific action users are combined into one cluster, a hierarchical structure from the lowest layer to the highest layer can be constructed.

The hierarchical structure constructed by the above processing is represented by a dendrogram as illustrated in FIG. 9. The dendrogram is a binary tree where each terminal node of the lowest layer represents each of n specific action users, and the cluster formed by combining is represented by each branch of the upper layer excluding the lowest layer. The horizontal axis of the dendrogram represents the distance between the clusters when combined. That is, the nodes close to each other have high similarity, and the nodes which are located at mutually separated positions have low similarity.

In the hierarchical structure of the dendrogram constructed as described above, for example, as illustrated in FIG. 9, the target user specification unit 32 specifies the plurality of specific action users belonging to a lower layer from a specific branch 71 of one specific layer as the analysis target user belonging to one group 72 and specifies the plurality of specific action users belonging to a lower layer from a specific branch 73 of the other specific layer as the comparison target user belonging to the other group 74.

In addition, the designation of one specific branch 71 to be performed for extracting the analysis target user and the designation of another specific branch 73 to be performed for extracting the comparison target user can be arbitrarily performed by the analyst manipulating the manipulation unit of the information analysis apparatus 101. In order to facilitate the designation of the branch, when the analyst performs manipulation to select an arbitrary branch, the feature information of the cluster corresponding to the branch may be displayed on the display.

By specifying the analysis target user and the comparison target user by the above described first pattern, the specific action users who have reached the specific state are set as the target, the specific action users of which feature information is different are specified as the analysis target user and the comparison target user, and comparison analysis can be performed. For example, with respect to the specific action user who has reached the specific state that a certain banner advertisement has been clicked, by specifying the analysis target user and the comparison target user by performing clustering on the basis of the feature information, it can be observed by the extraction of the peculiar information that even specific action users responding to the same banner advertisement are different in terms of motive or preference to reach the response.

In addition, according to the first pattern, since the clustering of specific action users is performed automatically, the clustering based on the user data and the specifying of the analysis target user and the comparison target user based thereon can be reasonably performed. On the other hand, an analyst can arbitrarily designate which of a plurality of groups generated by clustering as the analysis target user and which user as the comparison target user.

For example, it is possible to specify, as the analysis target user and the comparison target user, the groups having a relatively high similarity in the feature information (in the case of the dendrogram illustrated in FIG. 9, the groups with small distances between the clusters indicated by the horizontal axis). On the contrary, it is also possible to specify, as the analysis target user and the comparison target user, the groups having a relatively small similarity in the feature information (in the case of the dendrogram illustrated in FIG. 9, the group having the large distance between the clusters indicated by the horizontal axis). In addition, in the case of using the dendrogram illustrated in FIG. 9, the size of the group can be arbitrarily designated depending on which branch is designated. Therefore, it is possible to appropriately designate a group of analysis target users and a group of comparison target users according to the contents to be clarified by comparison analysis.

<Second Pattern>

On the basis of the action history information of a plurality of pieces of user data stored in the user data storage unit 10, the target user specification unit 32 specifies at least a portion of the specific action users indicated to have reached the action pattern of the specific stage among the action patterns of being transitioned to a plurality of stages as the analysis target user and specifies at least a portion of the users indicated to stay in the action pattern of the stage before the specific stage as the comparison target user.

Herein, as an example of the action pattern being transitioned through a plurality of stages, it is possible to use the action pattern on the basis of a purchasing action model which is well-known in marketing. That is, in the case of specifying the analysis target user and the comparison target user on the basis of the purchasing action model, the action corresponding to each stage of the purchasing action model is defined in advance, and the defined action and the action indicated by the action history information are combined, so that it is specified which stage of the purchasing action model each of the plurality of users specified by the plurality of pieces of user data has reached.

For example, in the case of specifying the analysis target user and the comparison target user on the basis of the purchasing action model of AISAS, the actions corresponding to the stages of attention, interest, search, action, and share are defined in advance, and it is specified which stage each of the plurality of users has reached on the basis of the action history information included in the user data. Then, the target user specification unit 32 specifies at least a portion of the specific action users indicated by the action history information to have reached the action of the second and subsequent stages among the above five stages as the analysis target user. In addition, the target user specification unit 32 specifies, as the comparison target user, at least a portion of the users indicated by the action history information to stay at the stage one stage before or a plurality of stages before the stage specified as the analysis target user. The conditions for specifying at least a portion are the same as those in the first embodiment or the second embodiment described above.

By specifying the analysis target user and the comparison target user by the second pattern described above, it is possible to estimate necessary or important elements for reaching the stage of the action being performed by the analysis target user by the extraction of the peculiar information.

Note that, in this example, the analysis target user and the comparison target user are specified on the basis of the purchasing action model of AISAS. However, in addition to this, the purchasing action model of the above-described AIDMA, AIDA, AIDCA, SIPS, and the like can be applied. In addition, it is also possible to apply the second pattern on the basis of stage decomposition by purchasing action model defined by Bayesian Network.

<Third Pattern>

On the basis of the plurality of pieces of user data stored in the user data storage unit 10, the target user specification unit 32 extracts at least a portion of the plurality of specific action users indicated by the action history information to have reached the specific state as the analysis target user. In addition, the target user specification unit 32 extracts the feature information from the user data relating to a plurality of user (for example, all users) including at least the analysis target user and other users among the plurality of pieces of user data stored in the user data storage unit 10 on the basis of the action history information and classifies the plurality of users into a plurality of groups on the basis of the similarity to the feature information of the analysis target user. Then, the users belonging to one of the plurality of groups are specified as the comparison target users.

Herein, the analysis target user is specified in the same manner similarly to the first embodiment or the second embodiment. In addition, the extraction of the feature information on the basis of the action history information may be the same as or different from the extraction of the feature information by the feature information extraction unit 13. Note that, in the first pattern described above, the feature information is extracted only for the specific action user indicated by the action history information to have reached the specific state. The third pattern is different from the first pattern in that the feature information is extracted from a plurality of users (for example, all users) stored in the user data storage unit 10.

In addition, similarly to the first pattern, various well-known techniques can be applied as a method of calculating the similarity of the extracted feature information. However, in the first pattern, the similarity of the feature information between the specific action users is calculated. Unlike, in the third pattern, the similarity to the feature information of the analysis target user is calculated.

For example, by performing machine learning by using the feature information of the analysis target user as the teacher data, it is possible to calculate the similarity to the feature information of the analysis target user with respect to the plurality of users stored in the user data storage unit 10. As a more specific example, if a learning machine is generated by, for example, the logistic regression method by setting the feature information of the analysis target user as a positive example and setting the feature information of the user group randomly sampled from all the user data stored in the user data storage unit 10 as a negative example, a prediction probability can be defined as the similarity for the analysis target user.

In addition, various well-known techniques can also be applied to a method of classifying users into a plurality of groups on the basis of the calculated similarity. Note that, in the first pattern, the similarity of the feature information between the specific action users is calculated, and the users with close similarity are grouped. Unlike, in the third pattern, the similarity to the feature information of the analysis target users is calculated, the plurality of users are classified into a plurality of groups on the basis of the similarity.

In addition, when a plurality of users are grouped, the boundary condition of classification may be obtained from a similarity distribution by a statistical method such as an F value. The F value is a statistical value representing a harmonic mean of the recall rate of classification and precision. That is, since the classifier has a tradeoff with the recall rate and precision, an index that can be evaluated by integrating the recall rate and the precision is required. One of the indexes is the F value. The F value can be expressed as 2Rec·Pre/(Rec+Pre) in a case where the recall rate is denoted by Rec and the precision is denoted by Pre. It is preferable that the target user specification unit 32 classifies the users into a plurality of groups by generating a classifier that increases the F value.

As another example, the target user specification unit 32 may classify the users into a plurality of groups by generating a classifier minimizing the GINI coefficient, which is an index for measuring the inequality of the similarity distribution. In addition, a classifier maximizing the Kullback-Leibler information amount (KL Divergence) or the Jensen-Shannon information amount (Jensen-Shannon Divergence) may be generated to classify users into a plurality of groups. Hereinafter, grouping using KL Divergence will be described.

Herein, for simplifying the description, it is considered to divide all the users stored in the user data storage unit 10 into three groups according to the similarity with respect to the feature information (positive example) of the analysis target user. The groups of the users belonging to each group at that time are denoted by A, B, and C, respectively. At this time, a user is denoted by u, similarity for the positive example is set to 0 s (u) 1, and user groups A, B, and C are defined as follows.

A={u|α≤s (u)≤1}

B={u|β≤s (u)<α}

C={u|0≤s (u)<β}

Herein, assuming that the occurrence probability of the feature information i in the user group A is A(i), the KL Divergence between the user group A and the user group B can be calculated by the following Mathematical Formula 5.

$${D}_{KL} ( A \vert \vert B ) = {\sum }_{i} A ( i ) log 〈 \frac{A ( i )}{B ( i )} 〉 \qquad ( Mathimatical Formula 5 )$$

Since it is preferable to maximize the value calculated by Mathematical Formula 5 for the entire system, the function S to be maximized is given by:

S(α, β)=D_{KL} (A||B)+D_{KL} (B||C).

When the value of the function S is maximized by a simulated annealing method with α and β as parameters, optimal division can be obtained.

In addition, in a case where the grouping is performed by using Jensen-Shannon Divergence, assuming that the occurrence probability of the feature information i in the user group A is A(i), the Jensen-Shannon Divergence between the user group A and the user group B can be calculated by following Mathematical Formula 6.

D_{JS}=1/2D_{KL} (A||M)+1/2D_{KL} (B ||M) (Mathematical Formula 6)

Herein, M =1/2 (A+B).

The target user specification unit 32 designates an arbitrary group among the plurality of groups generated as described above and specifies the users belonging to the group as the comparison target user. In addition, the designation of one group can be performed by the analyst manipulating the manipulation unit of the information analysis apparatus 103. Alternatively, a group that satisfies a specific condition with respect to similarity such as a group with the highest similarity or a group with the lowest similarity may be automatically specified. Alternatively, by setting the specific action user as the analysis target user and classifying a plurality of users (including non-specific action users) into a plurality of groups on the basis of the similarity to the feature information of the analysis target user, the group having the highest similarity and the group having the next highest similarity may be designated in order to search for a policy for shifting up the similarity of the non-specific action users to the group at the next level.

By specifying the analysis target user and the comparison target user by the third pattern described above, it is possible to specify, as the comparison target user to be compared with the specific action user who has reached the specific state, an arbitrary user among the users classified on the basis of the similarity to the feature information of the analysis target user. Therefore, it is possible to appropriately designate the comparison target user according to the content to be clarified by comparison analysis with respect to the analysis target user. In addition, in order to facilitate the designation, the height of similarity may be displayed on the display. In addition, when the analyst performs an operation to select an arbitrary group, the feature information corresponding to the group may be displayed on the display.

### Application Example

Although the information analysis apparatuses 101 to 103 according to the first to third embodiments have been described above, it is possible to variously utilize the analysis result (feature information peculiar to the analysis target user) by the comparison analysis unit 14. For example, it is possible to support the specification of promising users for distributing the advertisements of the products by using the result of analyzing the purchase of a certain product. In addition, it is possible to support the determination of promising appeal content when generating an advertisement for the product.

For example, by taking the peculiar information analyzed by the comparison analysis unit 14 for the analysis target user as a positive example and calculating the similarity to the feature information of all the users stored in the user data storage unit 10 (or 20), it is possible to perform the advertisement distribution to the user having the feature information with a high similarity other than the analysis target user. For example, in a case where the feature information included in Topic 4 having the maximum degree of peculiarity in the above-described (Table 2) is extracted as the peculiar information of the analysis target user, the peculiar information included in Topic 4 is taken as a positive example, and it is possible to distribute the advertisement to the user having the targeted feature by performing the advertisement distribution by grasping the user having the feature information having the large similarity to the peculiar information from the population.

In addition, when an analyst performs manipulation to designate a desired word from the words graphically displayed as illustrated in FIG. 2 or FIG. 7, the user having the designated word as the feature information may be segmented and the advertisement distribution may be performed.

In addition, the users with high similarity to the analysis target user may be obtained in advance to be used as the “all users” and “population”. Thus, for example, in a case where the analysis target user is a converted user, users who are similar in peculiar information and can easily convert can be targeted, and a higher advertisement effect can be expected.

As described above, in a case where the advertisement distribution is performed with the target being set, by determining whether or not the user to whom the advertisement distribution has been performed subsequently transitions to the same specific state as the analysis target user, the effect of the advertisement distribution may be evaluated. In addition, among the users to whom the advertisement distribution was performed, the ratio or number of users who have transitioned to the same specific state as the analysis target user is calculated as the evaluation value, and in a case where the evaluation value is equal to or less than a predetermined threshold value, the comparison target user may be re-defined, and the comparison analysis with the analysis target user may be executed again. In this case, by re-executing the grouping by one of the first pattern to the third pattern described in the third embodiment or re-executing the designation of any group, it is possible to re-define the comparison target user. Re-definition of the comparison target user may be automatically performed.

In addition, as an example of support for determining the contents of an advertisement appeal, it is possible to perform presentation of a promising advertisement strategy or present a promising catch phrase on the basis of the peculiar information analyzed by the comparison analysis unit 14 for the analysis target user. For example, in a case where the words, the category information, or the like relating to a low price is extracted as the peculiar information of the analysis target user, an advertisement strategy or a catch phrase for expressing the price is presented, while in a case where the words, the category information, or the like relating to performance is extracted as the peculiar information of the analysis target user, an advertisement strategy or a catch phrase for expressing the performance is presented.

In this case, with respect to a plurality of words or category information, related label information such as “price” or “performance” is predefined, and an advertisement strategy or a catch phrase to be presented is stored in advance in association with the label information. By doing so, by specifying the label information by using the words and category information included in the peculiar information analyzed by the comparison analysis unit 14 as a key, it is possible to obtain and present the advertisement strategy and catch phrase from the label information.

Note that, herein, the example where the label information is defined for each word or category information has been described, the label information may be defined for a topic. In addition, herein, the example where the advertisement strategy and catch phrase are stored in association with label information defined for word, category information, or a topic has been described. However, the advertisement strategy or the catch phrase may be stored in association with the label information and the user attribute information.

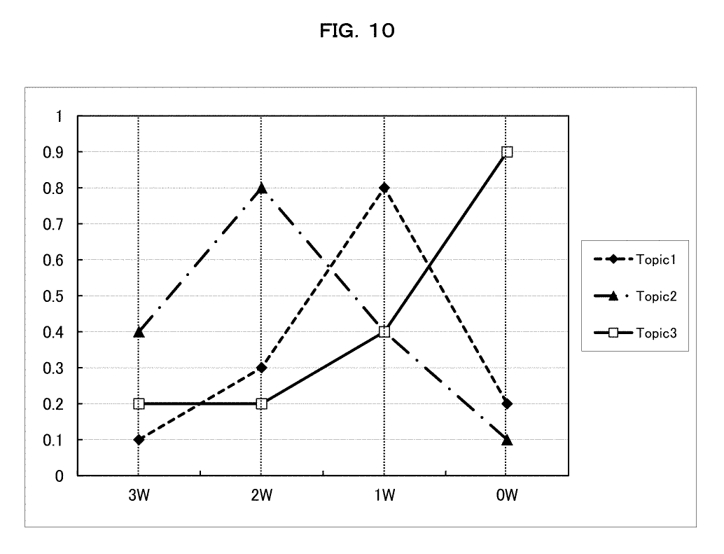

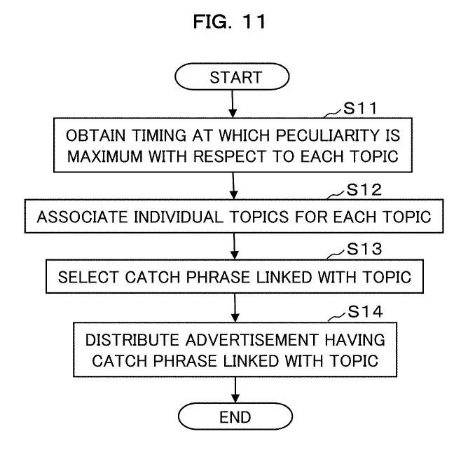

In addition, as illustrated in FIG. 3, the order of presenting the advertisements may be changed on the basis of the result of calculating the degree of peculiarity in time series. For example, it is assumed that the change in degree of peculiarity for four weeks of three topics is as follows (Table 3). FIG. 10 is a diagram illustrating an example of a graphic display in this case. FIG. 11 is a flowchart illustrating an operation example of the information analysis apparatus according to this application example and the advertisement distribution system used in combination with the information analysis apparatus.

TABLE 3

| | Three Weeks | Two Weeks | One Week | For Zero |
|---|---|---|---|---|
| Topic | Ago | Ago | Ago | Weeks |
| 1 | 0.1 | 0.3 | 0.8 | 0.2 |
| 2 | 0.4 | 0.8 | 0.4 | 0.1 |
| 3 | 0.2 | 0.2 | 0.4 | 0.9 |

Hereinafter, a specific example of the advertisement presentation method will be described according to the flowchart illustrated in FIG. 11. First, the catch phrase presentation unit (not shown) of the information analysis apparatus obtains the timing at which the degree of peculiarity becomes maximum with respect to each topic on the basis of the analysis result of the peculiar information output by the analysis result output unit 15 (step S11). Herein, in a case where the degree of peculiarity of the same maximum value has a plurality of times, for example, the earliest time is selected. In the case of the example of Table 3 and FIG. 10, Topic 1 has the highest degree of peculiarity one week ago, Topic 2 two weeks ago, and Topic 3 0 weeks ago.

Next, the catch phrase presentation unit associates the topic having the next highest degree of peculiarity at the timing at which the degree of peculiarity of the topic is maximum for each topic (step S12). Herein, in the case of the topic of which the maximum value of degree of peculiarity does not appear for a certain period of time, or in the case of the topic with the highest degree of peculiarity at the end, there may be no association. In the case of the example of Table 3 and FIG. 10, Topic 3 is set to be associated with Topic 1, Topic 1 is set to be associated with Topic 2, and Topic 3 is set to have no association.

Next, the catch phrase presentation unit selects a catch phrase to be linked with the topic (step S13). Herein, the catch phrase linked with each topic is taken as a catch phrase corresponding to the topic associated with the topic. In a case where there is no associated topic, the catch phrase of itself is used. For example, in a case where Topic 1 is a topic associated with price, Topic 2 is a topic associated with performance, and Topic 3 is a topic associated with delivery time, Topic 1 is set to be linked with the delivery time as the catch phrase of Topic 3, Topic 2 is set to be linked with the price as the catch phrase of Topic 1, and Topic 3 is set to be linked with the delivery time as the catch phrase of itself.

By the processing so far, as illustrated in the following (Table 4), the catch phrases are linked with each topic. The catch phrase presentation unit outputs the result of linking the catch phrases as described above to an advertisement distribution system (not shown).

TABLE 4

| | degree of | | | |
|---|---|---|---|---|
| | Peculiarity | Catch Phrase of | Associated | Linking |
| | Maximum Time | Topic itself | Topic | Catch Phrase |
| Topic 1 | One Week Ago | Price | Topic 3 | Delivery |
| | | | | Time |
| Topic 2 | Two Weeks Ago | Performance | Topic 1 | Price |
| Topic 3 | For Zero Weeks | Delivery | No | Delivery |
| | | Time | Association | Time |

The advertisement distribution system distributes the advertisement having catch phrases linked with each topic to the user. Herein, the user to be distributed can be decided, for example, by using the specific support method of the above-described advertisement distribution target user as an application example. That is, in a case where the feature information included in a topic with the highest degree of peculiarity is extracted as the peculiar information of the analysis target user, the peculiar information included in the topic is set as a positive example, and it is possible to perform the advertisement distribution by grasping the user having the peculiar information having the high similarity to the peculiar information from the population.

As described above, according to the method illustrated in FIG. 11, advertisement of a topic in which the user is likely to be interested next can be presented to the user who has been interested in a certain topic. Therefore, it can be expected that the user to which the advertisement is distributed is guided to the specific user state (in a condition where the analysis target user is extracted) more effectively or more quickly.

### Fourth Embodiment

Hereinafter, a fourth embodiment of the invention will be described with reference to the drawings. In the fourth embodiment, it is possible to support determination of an advertisement distribution target user which is a first application example of the application examples described above. In other words, the fourth embodiment is configured with specifying the advertisement distribution target user by using the peculiar information of the analysis target user by the comparison analysis unit 14, after that, evaluating a result of advertisement distribution, and feeding the evaluated result back to the next comparison analysis.

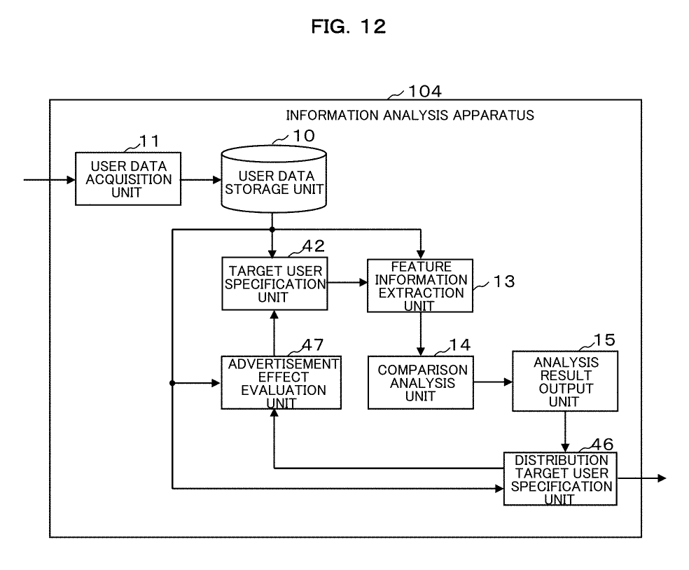

FIG. 12 is a block diagram illustrating a functional configuration example of an information analysis apparatus 104 according to the fourth embodiment. In FIG. 12, the components denoted by the same reference numerals as those illustrated in FIG. 1 have the same functions, and thus, redundant descriptions are omitted herein.

As illustrated in FIG. 12, the information analysis apparatus 104 according to the fourth embodiment includes, as functional configurations, the user data acquisition unit 11, a target user specification unit 42, the feature information extraction unit 13, the comparison analysis unit 14, the analysis result output unit 15, a distribution target user specification unit 46, and an advertisement effect evaluation unit 47. In addition, the information analysis apparatus 104 according to the fourth embodiment includes the user data storage unit 10 as a storage medium.

Each of the functional blocks 11, 42, 13 to 15, and 46 to 47 can be configured by any of hardware, DSP, and software. For example, in the case of being configured by software, each of the functional blocks 11, 42, 13 to 15, and 46 to 47 is actually configured with a CPU, a RAM, a ROM, and the like of a computer and is realized by operations of a program stored in a recording medium such as a RAM, a ROM, a hard disk, or a semiconductor memory.

On the basis of the user data stored in the user data storage unit 10, the distribution target user specification unit 46 extracts the feature information of each of all users or some users (for example, users other than the analysis target users or users extracted according to an arbitrary condition) on the basis of the action history information. Then, the distribution target user specification unit 46 sets, as a positive example, the result of the comparison analysis output by the analysis result output unit 15, that is, the peculiar information which is the feature information peculiar to the analysis target user, and calculates the similarity to the peculiar information of the extracted user, and specifies the user having the feature information having a high similarity as the advertisement distribution target user. The distribution target user specification unit 46 outputs the advertisement distribution target user as an analysis result and notifies the advertisement effect evaluation unit 47 of the analysis result.

The advertisement distribution system (not shown) distributes the advertisement to the target user specified by the distribution target user specification unit 46. Among the users who received this advertisement distribution, the user influenced by the advertisement takes some reaction. For example, there is a possibility of browsing detailed pages of a product or purchasing the product on the Internet. In this manner, when the user takes some action, the action is collected by the log collection server as action history information and acquired by the user data acquisition unit 11. Then, the user data stored in the user data storage unit 10 is updated.

On the basis of the action history information included in the user data stored in the user data storage unit 10, the advertisement effect evaluation unit 47 evaluates the effect of the advertisement distribution by determining whether or not the advertisement distribution target user notified from the distribution target user specification unit 46 is transitioned to the same specific state as the analysis target user. Herein, the ratio of the users who have been transitioned to the same specific state as the analysis target user among the advertisement distribution target users is calculated as the evaluation value, and it is determined whether or not the evaluation value is equal to or less than a predetermined threshold value.

In a case where the advertisement effect evaluation unit 47 determines that the evaluation value of the advertisement distribution effect is equal to or less than the predetermined threshold value, the target user specification unit 42 specifies the comparison target user for the analysis target user again. That is, the target user specification unit 42 automatically re-executes grouping according to one of the first pattern to the third pattern described in the third embodiment, and re-executes designation of any group.

For example, in a case where the grouping is performed by the first pattern or the third pattern, it is possible to re-execute grouping with the same pattern as the previous pattern and to specify the users belonging to the group with similarity different from the last time as the comparison target user. In this manner, there is a possibility that the feature information different from the last time may be analyzed as the feature information peculiar to the analysis target user, and in response to the result, the distribution target user specification unit 46 can specify the user different from the last time as the advertisement distribution target user. By repeating such loop processing, it is expected that advertisement distribution effect will be enhanced.

In addition, in a case where the grouping is performed according to the second pattern, the user belonging to the same stage as the last time is specified as the analysis target user, and the user staying at the same stage as the last time is specified as the comparison target user. That is, the analysis target user and the comparison target user are specified in exactly the same condition as the last time. Even though specified under the same condition, since the action history information of the user data stored in the user data storage unit 10 is updated from the last time, there is a possibility that results of different comparison analysis may be obtained. Therefore, there is a possibility that the distribution target user specification unit 46 can specify the user different from the last time as the advertisement distribution target user, and by repeating such loop processing, it is expected that the advertisement distribution effect will be enhanced.

Note that, in the first to fourth embodiments described above, the example of extracting, as the feature information, words included in a web page indicated by the action history information of the analysis target user to have been accessed, category information set as metadata for the web page, words that the user used for searching the web page, words that the user uttered to an AI speaker, position information of the store visited by the user, the user attribute information such as gender, age, occupation, annual income, family composition, and residence has been described. In addition to this, the position information of the user may be further extracted as the feature information. The position information of the user is, for example, position information of home, workplace, store frequently visited, facilities frequently visited, a travel destination, or the like.

In addition, in the first to fourth embodiments, the example where the user data acquisition units 11 and 21 analyze the user data acquired from the external log collection server and stored in the user data storage units 10 and 20 is described. However, the user data provided by the external service may be acquired and analyzed.

Besides, the above-described first to fourth embodiments are merely examples illustrating an embodiment for practicing the invention, and it should be noted that the technical scope of the invention is not interpreted in a limitative sense. That is, the invention can be implemented in various forms without departing from the spirit or the subject matters thereof.

1. An information analysis apparatus comprising:
a user data acquisition unit that acquires a plurality of pieces of user data having at least action history information;
a target user specification unit that specifies, as an analysis target user, at least a portion of specific action users indicated by the action history information to have reached a specific state on the basis of the plurality of pieces of user data acquired by the user data acquisition unit and specifies a user different from the analysis target user as a comparison target user;
a feature information extraction unit that extracts feature information of the analysis target user on the basis of the action history information of the analysis target user specified by the target user specification unit and extracts feature information of the comparison target user on the basis of the action history information of the comparison target user;
a comparison analysis unit that analyses peculiar information where the feature information of the analysis target user is feature information having peculiarity with respect to the feature information of the comparison target user; and
an analysis result output unit that outputs a result analyzed by the comparison analysis unit.

2. The information analysis apparatus according to claim 1,
wherein the user data acquisition unit acquires the plurality of pieces of user data having the action history information and user attribute information, and
the target user specification unit specifies the specific action user that is a user indicated by the user attribute information to have a specific user attribute and indicated by the action history information to have reached the specific state as the analysis target user on the basis of the plurality of pieces of user data acquired by the user data acquisition unit and specifies the user different from the analysis target user as the comparison target user.

3. The information analysis apparatus according to claim 2, wherein the feature information extraction unit extracts the feature information of the analysis target user on the basis of the action history information and the user attribute information of the analysis target user specified by the target user specification unit and extracts the feature information of the comparison target user on the basis of the action history information and the user attribute information of the comparison target user.

4. The information analysis apparatus according to claim 1, wherein the target user specification unit extracts the feature information with respect to each of the plurality of specific action users indicated by the action history information to have reached the specific state on the basis of the action history information, classifies the specific action users into a plurality of groups on the basis of similarity of the feature information, specifies the specific action user belonging to one group as the analysis target user, and specifies the specific action user belonging to other groups as the comparison target user.

5. The information analysis apparatus according to claim 1, wherein the target user specification unit specifies, as the analysis target user, at least a portion of the specific action users indicated to have reached an action pattern at a specific stage among action patterns that are transitioned through a plurality of stages on the basis of the action history information of the plurality of pieces of user data acquired by the user data acquisition unit and specifies, as the comparison target user, at least a portion of the users indicated to stay in an action pattern at a stage before the specific stage.

6. The information analysis apparatus according to claim 1, wherein the target user specification unit
specifies, as the analysis target user, at least a portion of the plurality of specific action users indicated by the action history information to have reached the specific state on the basis of the plurality of pieces of user data acquired by the user data acquisition unit and
extracts the feature information on the basis of the action history information using the user data on a plurality of users including at least the analysis target user and other users among the plurality of pieces of user data acquired by the user data acquisition unit, classifies the plurality of users into a plurality of groups on the basis of a similarity to the feature information of the analysis target user, and specifies the users belonging to one of the plurality of groups as the comparison target user.

7. The information analysis apparatus according to claim 1, wherein the comparison analysis unit calculates the degree of peculiarity of the feature information of the analysis target user with respect to the feature information of the comparison target user and analyzes the feature information of which degree of peculiarity satisfies a predetermined condition as the peculiar information.

8. The information analysis apparatus according to claim 1,
wherein the feature information extraction unit delimits a plurality of target periods in unit of a predetermined time period backward from a time point when the analysis target user has reached the specific state and extracts the feature information of the analysis target user and the feature information of the comparison target user for each of the plurality of target periods,
the comparison analysis unit analyzes the feature information of the analysis target user having the peculiarity with respect to the feature information of the comparison target user as the peculiar information for each of the plurality of target periods, and
the analysis result output unit outputs results analyzed by the comparison analysis unit for each of the plurality of target periods.

9. The information analysis apparatus according to claim 1, wherein the analysis result output unit graphically outputs the peculiar information analyzed by the comparison analysis unit and other feature information and outputs the peculiar information in a conspicuous manner as compared with the other feature information.

10. The information analysis apparatus according to claim 8, wherein the analysis result output unit graphically outputs the peculiar information analyzed by the comparison analysis unit and other feature information and outputs the peculiar information and other feature information in an identifiable manner for each of the plurality of target periods,

11. The information analysis apparatus according to claim 4, further comprising a distribution target user specification unit that extracts the feature information of all the users or some users on the basis of action history information included in the plurality of pieces of user data acquired by the user data acquisition unit, calculates similarity between the peculiar information of the analysis target user which is an analysis result output by the analysis result output unit and the feature information, and specifies a user having the feature information with a high similarity as an advertisement distribution target user.

12. The information analysis apparatus according to claim 5, further comprising a distribution target user specification unit that extracts the feature information of all the users or some users on the basis of action history information included in the plurality of pieces of user data acquired by the user data acquisition unit, calculates similarity between the peculiar information of the analysis target user which is an analysis result output by the analysis result output unit and the feature information, and specifies a user having the feature information with a high similarity as an advertisement distribution target user.

13. The information analysis apparatus according to claim 6, further comprising a distribution target user specification unit that extracts the feature information of all the users or some users on the basis of action history information included in the plurality of pieces of user data acquired by the user data acquisition unit, calculates similarity between the peculiar information of the analysis target user which is an analysis result output by the analysis result output unit and the feature information, and specifies a user having the feature information with a high similarity as an advertisement distribution target user.

14. The information analysis apparatus according to claim 11, further comprising an advertisement effect evaluation unit that evaluates an effect of advertisement distribution by determining whether or not the advertisement distribution target user specified by the distribution target user specification unit has been transitioned to the same specific state as the analysis target user on the basis of the action history information included in the plurality of pieces of user data acquired by the user data acquisition unit.

15. The information analysis apparatus according to claim 12, further comprising an advertisement effect evaluation unit that evaluates an effect of advertisement distribution by determining whether or not the advertisement distribution target user specified by the distribution target user specification unit has been transitioned to the same specific state as the analysis target user on the basis of the action history information included in the plurality of pieces of user data acquired by the user data acquisition unit.

16. The information analysis apparatus according to claim 13, further comprising an advertisement effect evaluation unit that evaluates an effect of advertisement distribution by determining whether or not the advertisement distribution target user specified by the distribution target user specification unit has been transitioned to the same specific state as the analysis target user on the basis of the action history information included in the plurality of pieces of user data acquired by the user data acquisition unit.

17. The information analysis apparatus according to claim 14,
wherein the advertisement effect evaluation unit calculates a ratio or the number of the users who have been transitioned to the same specific state as the analysis target user among the advertisement distribution target users as an evaluation value and determines whether or not the evaluation value is equal to or less than a predetermined threshold value, and
in a case where it is determined by the advertisement effect evaluation unit that the evaluation value is equal to or less than the predetermined threshold value, the target user specification unit specifies the comparison target user for the analysis target user again.

18. The information analysis apparatus according to claim 15,
wherein the advertisement effect evaluation unit calculates a ratio or the number of the users who have been transitioned to the same specific state as the analysis target user among the advertisement distribution target users as an evaluation value and determines whether or not the evaluation value is equal to or less than a predetermined threshold value, and
in a case where it is determined by the advertisement effect evaluation unit that the evaluation value is equal to or less than the predetermined threshold value, the target user specification unit specifies the comparison target user for the analysis target user again.

19. The information analysis apparatus according to claim 16,
wherein the advertisement effect evaluation unit calculates a ratio or the number of the users who have been transitioned to the same specific state as the analysis target user among the advertisement distribution target users as an evaluation value and determines whether or not the evaluation value is equal to or less than a predetermined threshold value, and
in a case where it is determined by the advertisement effect evaluation unit that the evaluation value is equal to or less than the predetermined threshold value, the target user specification unit specifies the comparison target user for the analysis target user again.

20. The information analysis apparatus according to claim 1, further comprising a catch phrase presentation unit that presents a catch phrase of an advertisement that is associated in advance with a topic obtained by grouping the feature information which is the peculiar information or the plurality of pieces of feature information on the basis of a predetermined common item, on the basis of the analysis result of the peculiar information by the comparison analysis unit output by the analysis result output unit.

21. The information analysis apparatus according to claim 20,
wherein the comparison analysis unit calculates the degree of peculiarity of the feature information of the analysis target user with respect to the feature information of the comparison target user, and
the catch phrase presentation unit associates another topic with the topic of the peculiar information output by the analysis result output unit on the basis of the degree of peculiarity and presents a catch phrase of the advertisement that is associated with the other topic in advance in place of or in addition to a catch phrase of the advertisement that is associated with the topic of the peculiar information.

22. An information analysis method, comprising:
a first step of a user data acquisition unit of an information analysis apparatus acquiring a plurality of pieces of user data having at least action history information;
a second step of a target user specification unit of the information analysis apparatus specifying, as an analysis target user, at least a portion of specific action users indicated by the action history information to have reached a specific state on the basis of the plurality of pieces of user data acquired by the user data acquisition unit and specifying a user different from the analysis target user as a comparison target user;
a third step of a feature information extraction unit of the information analysis apparatus extracting the feature information of the analysis target user on the basis of the action history information of the analysis target user specified by the target user specification unit and extracting the feature information of the comparison target user on the basis of action history information of the comparison target user;
a fourth step of a comparison analysis unit of the information analysis apparatus analyzing peculiar information where the feature information of the analysis target user is feature information having peculiarity with respect to the feature information of the comparison target user; and
a fifth step of an analysis result output unit of the information analysis apparatus outputting a result analyzed by the comparison analysis unit.

23. An information analysis program causing a computer to function as:
a user data acquisition unit that acquires a plurality of pieces of user data having at least action history information;
a target user specification unit that specifies, as an analysis target user, at least a portion of specific action users indicated by the action history information to have reached a specific state on the basis of the plurality of pieces of user data acquired by the user data acquisition unit and specifies a user different from the analysis target user as a comparison target user;
a feature information extraction unit that extracts feature information of the analysis target user on the basis of the action history information of the analysis target user specified by the target user specification unit and extracts feature information of the comparison target user on the basis of the action history information of the comparison target user;
a comparison analysis unit that analyses peculiar information where the feature information of the analysis target user is feature information having peculiarity with respect to the feature information of the comparison target user; and
an analysis result output unit that outputs a result analyzed by the comparison analysis unit.
